(19) United States
(12) Patent Application Publication
(10) Pub. No.: US 2006/0017364 A1
(43) Pub. Date: Jan. 26, 2006

(54) Compact fluorescent lamps

(75) Inventors: Zhongwei Cai, Shanghai (CN); Jinzhong Yang, Shanghai (CN)

Correspondence Address: SILICON VALLEY PATENT AGENCY, 7394 WILDFLOWER WAY, CUPERTINO, CA, 95014, US

(73) Assignee: Shanghai Zhengbei Lighting Appliance Co., Ltd., Shanghai (CN)

(21) Appl. No.: 11/175,793

(22) Filed: Jul. 5, 2005

(30) Foreign Application Priority Data
Jul. 21, 2004 (CN) 2004200377620

(51) Int. Cl. H01J 5/48; H01J 5/50

(52) U.S. Cl. 313/318.01

(57) ABSTRACT

Techniques of designing compact fluorescent lamps are disclosed. Instead of embedding a ballast in a chamber between a lamp base and lamp tubes, the ballast is substantially enclosed in a space formed by the lamp tubes. As a result, the overall size of a fluorescent lamp is reduced.

### BACKGROUND OF THE INVENTION

1. Field of the Invention

The present invention relates to the area of fluorescent lamps. Particularly, the present invention is related to a compact fluorescent lamp enclosing a ballast in a manner that the overall size of the lamp is significantly reduced and the method for making the same.

2. Description of the Related Art

Fluorescent-based energy saving lamps have been used widely in residential and industrial lightings because of their high efficiency in light outputs and energy. Moreover, these types of lamps are being highly promoted by the government.

FIG. 1 shows a structure for a traditional fluorescent lamp. As shown in the figure, the lamp includes a lamp base (1), a housing (2) and a lamp tubes (3). The housing (2) includes a housing cover (2A) and a housing space (2B), wherein the housing cover (2A) and a housing space (2B) form a chamber to embed a ballast therein. The tubes (3) are constructed on top of the housing cover (2A) in multiple shapes such as U-shaped, Π-shaped or spiral shaped.

One of the issues in the structure of the traditional fluorescent lamp is the inherent size because the base(1), housing (2) and tubes(3) are connected directly in a line with the embedded ballast in the housing (2). Based on the current manufacturing technology, an electronic ballast is quite large in size. Therefore the size of the housing (2) is subject to that of the ballast. As a result, the housing (2) contributes significantly to the overall size or length of the lamp. Essentially the housing in the traditional fluorescent lamp restricts the compactness of a fluorescent lamp, especially in those lower power or shorter tube lamps, and becoming a barrier for further miniaturization and compactness of low power and energy saving fluorescent lamps. There is thus a need for energy saving fluorescent lamps in compact size.

### BRIEF DESCRIPTION OF THE DRAWINGS

The present invention will be readily understood by the following detailed description in conjunction with the accompanying drawings, wherein like reference numerals designate like structural elements, and in which:

FIG. 1 shows a structure for a traditional fluorescent lamp; and

FIG. 2 shows a cross-section view of a fluorescent lamp in accordance with one embodiment of the present invention.

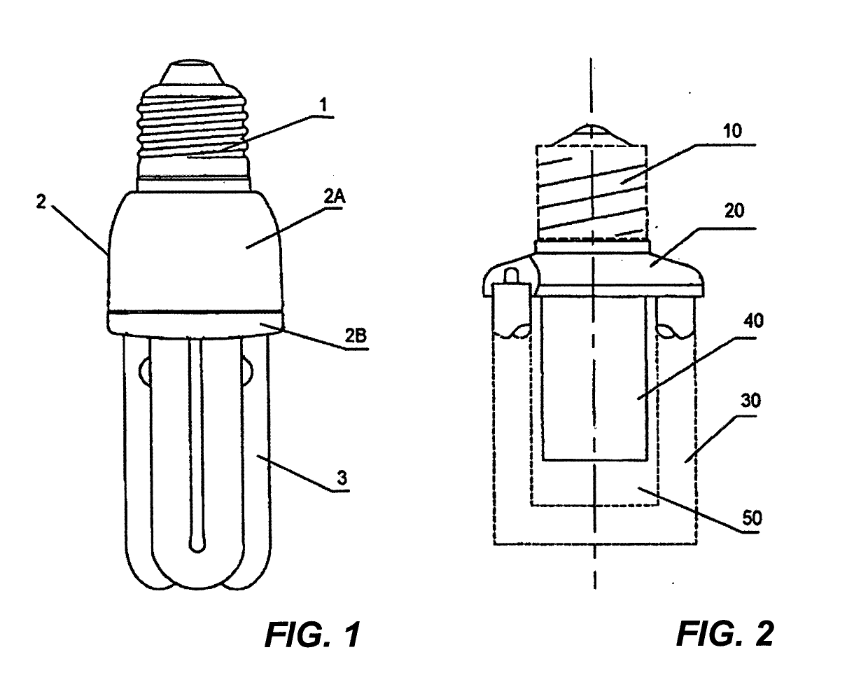

### DETAILED DESCRIPTION OF THE INVENTION

The present invention pertains to techniques of designing compact fluorescent lamps and a method for doing the same. According to one aspect of the present invention, instead of embedding a ballast in a chamber between a lamp base and lamp tubes, the ballast is enclosed in a space formed by the lamp tubes. As a result, the overall size of a fluorescent lamp is reduced. Fluorescent lamps manufactured in accordance with the present invention appear more compact. In one embodiment, the fluorescent lamps appear closer to the traditional incandescent lamps.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

Embodiments of the present invention are discussed herein with reference to FIG. 2 that is provided for illustration and to facilitate the understanding of the present invention. However, those skilled in the art will readily appreciate that the detailed description given herein with respect to these figures is for explanatory purposes as the invention extends beyond these limited embodiments.

Referring now to FIG. 2, there shows a cross-view of an exemplary embodiment of a fluorescent lamp according to the present invention. As shown in FIG. 2, the fluorescent lamp includes a lamp base (10), a tube holder (20), lamp tubes (30), and a ballast (40). In one embodiment, the lamp base (10) is designed identical to that of an incandescent lamp and can be plugged or screwed in a traditional lamp socket to receive electricity to drive the lamp.

The lamp base (10) is connected to the tube holder, and the tubes (30) are mounted on top of or supported by the tube holder (20). In particular, the tubes (30) are structured and mounted in such a way that a space (50) is formed by the tubes (30). The ballast (40) is positioned in the space (50) and supported by the tube holder (20). One of the important features in the present invention is that the ballast is positioned in a space formed by the tubes such that the size, especially the length, of a fluorescent lamp is significantly reduced.

The tubes may be structured in a number of shapes to form a space in the middle that is large enough to accommodate the ballast. One example of the shapes is of spiral, in which tubes are wound around the space. The present invention has numerous advantages, benefits and features. One of them is the overall reduced size of a fluorescent lamp by positioning a ballast in a space formed by the light tubes. Another one of them is that a fluorescent lamp designed in accordance with the present invention makes the fluorescent lamp look closer to an incandescent lamp and fit more easily in a conventional socket for an incandescent lamp.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. For example, the ballast may be partially in a chamber space and partially in the space formed by the tubes, which still reduce the overall size of the lamp. Accordingly, the scope of the present invention is defined by the appended claims rather than the forgoing description of embodiments.

We claim:

1. A fluorescent lamp comprises:
a base suitable for being screwed into a socket;
a tube holder connected to the base and supporting tubes; and
a ballast positioned substantially in a space formed by the tubes.

2. The fluorescent lamp as recited in claim 1, wherein the ballast is also supported on the tube holder and electrically connected to the base.

3. The fluorescent lamp as recited in claim 1, wherein the tubes are constructed on top of the tube holder in a shape that provides the space for the ballast.

4. The fluorescent lamp as recited in claim 3, wherein the shape is one of spiral shaped, U-shaped, and Π-shaped.

5. The fluorescent lamp recited in claim 1, wherein any remaining portion of the ballast, if any, not in the space is embedded in a chamber built into the tube holder.

6. A fluorescent lamp comprises:
a base suitable for coupled to a socket;
a tube holder connected to the base and supporting tubes, wherein the tubes are wound on top of the tube holder in a manner that provides a space amid the tubes; and
a ballast embedded in the space so that there is no need for a chamber between the base and the tube holder to embed the ballast.

7. The fluorescent lamp as recited in claim 6, wherein the ballast is electrically connected to the base.

8. The fluorescent lamp as recited in claim 6, wherein the manner the tubes are wound includes one of spiral shaped, U-shaped, and Π-shaped.

9. A method for providing a fluorescent lamp, the method comprising:
providing a space to hide a ballast in a space, wherein the space is formed by winding tubes around the space, the tubes are supported by a tube holder; and
connecting a lamp base to the tube holder.

10. The method as recited in claim 9, wherein the base is suitable for being plugged or screwed into a socket.

11. The method as recited in claim 9, wherein the tube holder has a chamber to receive a portion of the ballast.

12. The method as recited in claim 11, wherein the fluorescent lamp is much shorter in length than a traditional fluorescent lamp that has the ballast completely in a chamber of a housing as a tuber holder.
